(19) United States
(12) Patent Application Publication
(10) Pub. No.: US 2018/0111292 A1
(43) Pub. Date: Apr. 26, 2018

(54) FOAM MOLDED BODY PRODUCTION DEVICE, FOAM MOLDED BODY PRODUCTION METHOD, AND FOAM MOLDED BODY

(71) Applicant: BRIDGESTONE CORPORATION, Tokyo (JP)

(72) Inventors: Kenji KUMAGAI, Tokyo (JP); Taisuke YONEZAWA, Tokyo (JP); Toshimitsu SHINOHARA, Tokyo (JP); Yoshiyuki TAKAHASHI, Tokyo (JP)

(73) Assignee: BRIDGESTONE CORPORATION, Tokyo (JP)

(21) Appl. No.: 15/571,167

(22) PCT Filed: Apr. 22, 2016
(86) PCT No.: PCT/JP2016/062838

§ 371 Date: Nov. 1, 2017

(30) Foreign Application Priority Data
May 28, 2015 (JP) 2015-108155

(51) Int. Cl. B29C 33/50; B29C 39/04; B29C 39/34; B60N 2/90; A47C 7/02; B29C 44/02

(52) U.S. Cl. CPC B29C 33/50; B29C 39/04; B29C 39/34; B29K 2075/00; A47C 7/02; B29C 44/02; B60N 2/90

(57) ABSTRACT

A foam molded body production device (20) including a plurality of molds (21); a cavity (23) that is delimited, between the plurality of molds (21), by cavity surfaces (22) of the plurality of molds (21); and a protrusion portion (28) that is formed on the cavity surfaces (22). The protrusion portion (28) is formed from an elastic body. The cavity surfaces (22) are provided with a holding portion (29) that contacts a tip of the protrusion portion (28) when the plurality of molds (21) are closed, and causes the protrusion portion (28) to elastically deform inside the cavity (23).

### TECHNICAL FIELD

The present invention relates to a foam molded body production device, a foam molded body production method and a foam molded body.

The present application claims priority on Japanese Patent Application No. 2015-108155, filed May 28, 2015, the content of which is incorporated herein by reference.

### BACKGROUND ART

Conventionally, foam molded body production devices such as that described, for example, in the below-mentioned Patent Document 1, are known. This production device comprises a cavity that is delimited by respective cavity surfaces of a plurality of molds. Protrusion portions are formed on a cavity surface.

### RELATED DOCUMENT

### Patent Document

### [Patent Document 1]

JP 2003-94452 A

### SUMMARY OF INVENTION

### Technical Problem

In the aforementioned conventional foam molded body production devices, the foam molded body is released from the cavity surfaces by opening the plurality of molds after the foam molded body has been molded inside the cavity. There is room for improvement, at that time, in terms of maintaining the positions of the protrusion portions inside the cavity with high precision, while ensuring the mold releasability of the foam molded body.

The present invention was made in consideration of the aforementioned circumstances, and has the purpose of maintaining the positions of protrusion portions inside a cavity with high precision, while ensuring the mold releasability of a foam molded body.

### Solution to Problem

The present invention proposes the following means for solving the aforementioned problem.

The foam molded body production device according to the present invention comprises a plurality of molds; a cavity that is delimited, between the plurality of molds, by cavity surfaces of the plurality of molds; and a protrusion portion that is formed on the cavity surfaces. The protrusion portion is formed from an elastic body. The cavity surfaces are provided with a holding portion that contacts a tip of the protrusion portion when the plurality of molds are closed, and causes the protrusion portion to elastically deform inside the cavity.

### Advantageous Effects of Invention

According to the present invention, it is possible to maintain the positions of protrusion portions inside a cavity with high precision, while ensuring the mold releasability of a foam molded body.

### BRIEF DESCRIPTION OF DRAWINGS

FIG. 1 is a section view of a seat pad according to an embodiment of the present invention.

FIG. 2 is a section view of a die for forming the seat pad illustrated in FIG. 1.

FIG. 3 is an enlarged view of an essential portion including a protrusion portion and a holding portion forming the die illustrated in FIG. 2.

FIG. 4 is the same view as the enlarged view of the essential portion illustrated in FIG. 3, showing a state in which the protrusion portion and the holding portion are separated.

### DESCRIPTION OF EMBODIMENTS

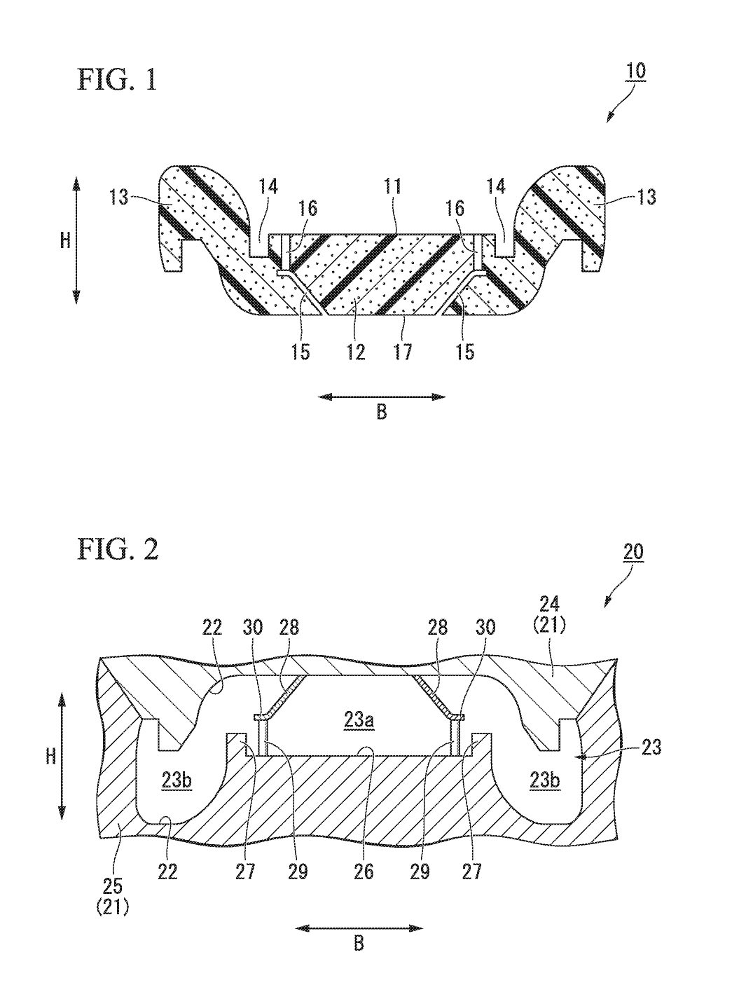

Herebelow, a seat pad 10 according to an embodiment of the present invention will be explained with reference to FIG. 1 to 4.

As illustrated in FIG. 1, the seat pad 10 is formed from a foamed molded body. The foamed molded body may be a soft resin foam molded body such as, for example, a soft polyurethane foam (soft resin) or the like, that is molded by foaming a resin material.

The seat pad 10 is used, for example, as a seat installed in an automobile (vehicle). The seat pad 10 comprises a sitting surface 11 (loading surface) with which a passenger comes into contact when sitting on the seat. In the present embodiment, the seat pad 10 is used as a cushion pad. When the seat pad 10 is installed in an automobile, the sitting surface 11 faces upwards in the vertical direction, and is parallel to the front-rear direction and the left-right direction of the automobile. The weight of the passenger acts on the seat pad 10 from above.

The seat pad 10 is formed in the shape of a flattened rectangular parallelepiped. The direction orthogonal to the sitting surface 11 on the seat pad 10 is the thickness direction H of the seat pad 10.

The seat pad 10 comprises a body portion 12 (first foam body) and a side portion 13 (second foam body) that are integrally molded from materials that are different from each other. The body portion 12 has a lower hardness than the side portion 13. The side portion 13 is formed along the outer peripheral edges of the body portion 12. The side portion 13 sandwiches the body portion 12 from both sides in the seat width direction B (first lateral direction) parallel to the sitting surface 11. Suspended grooves 14 that extend in the orthogonal direction (one direction) orthogonal to the seat width direction B and parallel to the sitting surface 11 open onto the sitting surface 11. The suspended grooves 14 are recessed from the sitting surface 11 towards the side opposite to the sitting surface (side opposite to the loading surface) in the thickness direction H.

The body portion 12 and the side portion 13 are separated by slit portions 15 and intermittent holes 16. The slit portions 15 open onto an installation surface 17 (rear surface), which is the surface of the seat pad 10 that faces towards the side (sitting-surface-opposite side, loading-surface-opposite side) opposite to the sitting surface 11. The slit portions 15 are recessed in the upward direction from the installation surface 17. The slit portions 15 extend from the inside towards the outside of the seat pad 10 in the seat width direction B. The slit portions 15 gradually progress upwards as they extend towards the outside in the seat width direction B.

The end portions of the slit portions 15 to the inside in the seat width direction B open onto surfaces of the seat pad 10. The end portions of the slit portions 15 to the outside in the seat width direction B do not open onto surfaces of the seat pad 10.

A plurality of the intermittent holes 16 are arranged so as to be spaced in the orthogonal direction. The intermittent holes 16 open onto the sitting surface 11. The intermittent holes 16 extend from the sitting surface 11 towards the side opposite to the sitting surface (installation surface 17 side) in the thickness direction H. The end portions of the intermittent holes 16 are connected to the end portions of the slit portions 15 on the outside in the seat width direction B.

The body portion 12 and the side portion 13 are separated in the seat width direction B by the slit portions 15 and the intermittent holes 16. The side portion 13 extends underneath the body portion 12, towards the side opposite to the sitting surface (side opposite to the loading surface) in the thickness direction H, at both end portions of the body portion 12 in the seat width direction B.

According to the seat pad 10 as described above, when a passenger sits on the sitting surface 11, the seat pad 10 is deformed so that the slit portions 15 are narrowed in the thickness direction H, thereby allowing the seat pad 10 to sag by an appropriate amount while suppressing the hardness that is felt from the seat pad 10. Due thereto, it is possible to improve the sitting comfort, for example, when sitting or during cornering or the like.

Additionally, the slit portions 15 penetrate through the seat pad 10 in the thickness direction H via the intermittent holes 16, thereby raising the ventilation level.

Next, a die 20 (foam molded body production device) for forming the seat pad 10 will be explained.

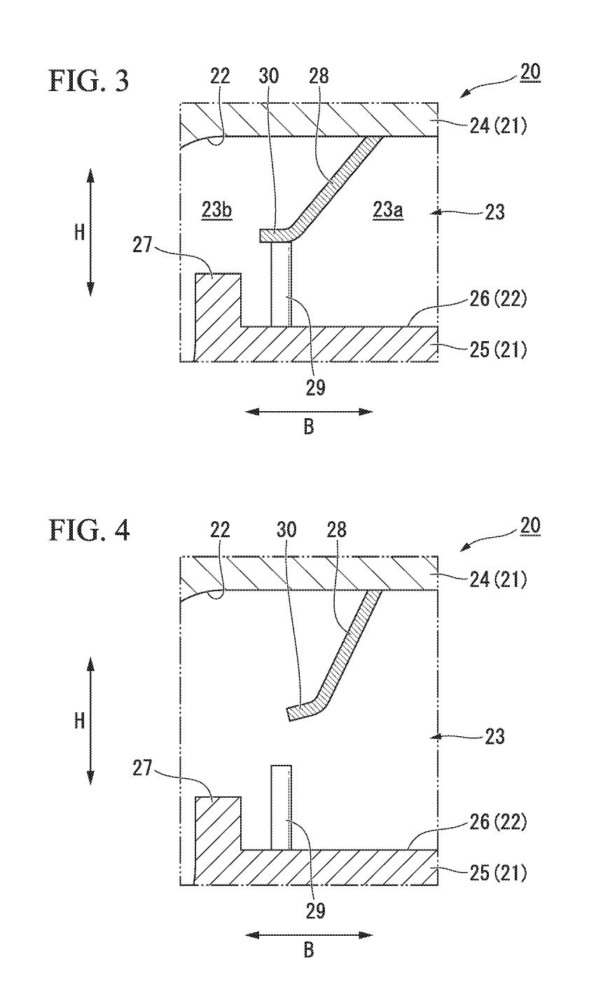

As illustrated in FIGS. 2 and 3, the die 20 comprises a plurality of molds 21 and a cavity 23. The cavity 23 is delimited, between the plurality of molds 21, by cavity surfaces 22 of the plurality of molds 21. The cavity 23 is formed so as to be in the same shape and the same size as the seat pad 10. In the present embodiment, an upper mold 24 and a lower mold 25 are provided as the plurality of molds 21. A sitting surface formation portion 26 (loading surface formation portion) for forming the sitting surface 11 of the seat pad 10 is provided in the cavity surface 22 of the lower mold 25. The plurality of molds 21 open and close in the thickness direction H (opening/closing direction of the plurality of molds) along the vertical direction, orthogonal to the sitting surface formation portion 26.

Groove formation portions 27, protrusion portions 28 (slit formation portions) and holding portions 29 are formed on the cavity surfaces 22. In other words, the die 20 comprises groove formation portions 27, protrusion portions 28 and holding portions 29.

The groove formation portions 27 form the suspended grooves 14. The groove formation portions 27 protrude from the sitting surface formation portion 26 towards the upper mold 24. The groove formation portions 27 are arranged in a pair that is spaced in the sheet width direction B parallel to the sitting surface formation portion 26. The pair of the groove formation portions 27 is formed so as to be of the same shape and the same size as each other.

The protrusion portions 28 are formed from elastic bodies. The protrusion portions 28 form the slit portions 15 and also form the boundary surfaces between the body portion 12 and the side portions 13. In the present embodiment, the protrusion portions 28 are formed, for example, from PP (polypropylene). PET (polyethylene terephthalate) or the like, and are formed so as to be easily releasable from the seat pad 10 molded inside the cavity 23.

The protrusion portions 28 protrude from a cavity surface 22 into the cavity 23. The protrusion portions 28 are formed on the cavity surface 22 of the upper mold 24, and protrude from the upper mold 24 towards the lower mold 25. The protrusion portion 28 extends in the seat width direction B from the inside towards the outside of the cavity 23. The protrusion portions 28 extend obliquely with respect to the thickness direction H, and gradually progress towards the outside in the seat width direction B as they extend from the upper mold 24 towards the lower mold 25.

The protrusion portions 28 are formed in the shape of plates of which the front and back surfaces face in the thickness direction H. In a plan view of the cavity surface 22 on which the protrusion portions 28 are formed, the protrusion portions 28 extend straightly along the orthogonal direction (one direction) orthogonal to the seat width direction B, parallel to the sitting surface formation portion 26.

Sliding portions 30 are formed on the tips of the protrusion portions 28. The sliding portions 30 are formed by bending the tips of the protrusion portions 28 towards the outside in the seat width direction B.

When the plurality of molds 21 are closed, the holding portions 29 make contact with the tips of the protrusion portions 28, or with the sliding portions 30 in the illustrated example, and elastically deform the protrusion portions 28 in the thickness direction II inside the cavity 23. Of the cavity surfaces 22 of the plurality of molds 21, the holding portions 29 are provided on a cavity surface 22 that is different from the cavity surface 22 on which the protrusion portions 28 are formed. The holding portions 29 are formed from rigid bodies, and protrude from a cavity surface 22. The holding portions 29 extend straightly along the thickness direction H and receive the reaction force from the protrusion portions 28 in the thickness direction H. The holding portions 29 are formed as cylinders extending in the thickness direction H. A plurality of the holding portions 29 is arranged in the orthogonal direction, with spacing therebetween.

The protrusion portions 28 and the holding portions 29 partition the cavity 23 into a first cavity 23a for molding the body portion 12 and a second cavity 23b for molding the side portion 13. The first cavity 23a is separated into a central part of the cavity 23 in the seat width direction B. The second cavity 23b is separated into side parts of the cavity 23 in the seat width direction B. The protrusion portions 28 gradually progress towards the second cavity 23b as they extend towards the lower mold 25.

In a seat pad production method (foam molded body production method) for forming the seat pad 10 using the die 20, as shown in FIG. 2, the seat pad 10 is molded inside the cavity 23 in which the tips of the protrusion portions 28 are held by the holding portions 29. Thereafter, the plurality of molds 21 is opened, and the seat pad 10 is released from cavity surfaces 22 while elastically deforming the protrusion portions 28. Due thereto, it is possible to make the seat pad 10 easily releasable from the cavity surfaces 22 while maintaining the positions of the protrusion portions 28 inside the cavity 23 with high precision.

As illustrated in FIGS. 3 and 4, when closing the plurality of molds 21, the protrusion portions 28 are elastically deformed in the thickness direction 1H by sliding the sliding portions 30 of the protrusion portions 28 over the holding portions 29. At this time, the protrusion portions 28 swing about the bases of the protrusions portions 28, in the thickness direction H, away from the sitting surface formation portion 26.

As explained above, according to the die 20 of the present embodiment, holding portions 29 are provided on a cavity surface 22. Therefore, the protrusion portions 28 can be held from both the bases and the tips thereof, by having the tips of the protrusion portions 28 make contact with the holding portions 29 inside the cavity 23. Therefore, it is possible to restrict the protrusion portions 28 from being unexpectedly deformed or displaced inside the cavity 23, and the positions of the protrusion portions 28 inside the cavity 23 can be maintained with high precision. Due thereto, for example, the positions of the boundary surfaces between the body portion 12 and the side portion 13 and the positions of the slit portions 15 can be precisely formed and the like.

Furthermore, the protrusion portions 28 are formed form elastic bodies. Thus, when the plurality of molds 21 are opened after molding a seat pad 10 inside the cavity 23, the seat pad 10 can be released from a cavity surface 22 while elastically deforming the protrusion portions 28. Therefore, when releasing the seat pad 10 from the cavity surfaces 22, it is possible, for example, to keep the protrusion portions 28 from catching on the seat pad 10 and the like. Due thereto, it is possible to prevent damage to the seat pad 10 while making it easier to release the seat pad 10 from the cavity surfaces 22.

Additionally, as mentioned above, the seat pad 10 can be released from the cavity surfaces 22 while elastically deforming the protrusion portions 28. Therefore, when releasing the seat pad 10, it is possible to prevent an excessive load from being applied to the protrusion portions 28, and the protrusion portions 28 can be formed so as to be thin overall. Due thereto, the thinness of the slit portions 15 can be set with a high degree of freedom when forming the slit portions 15 in the seat pad 10 by means of the protrusion portions 28.

Additionally, the holding portions 29 protrude from a cavity surface 22. Therefore, it is possible to prevent, for example, the tips of the protrusion portions 28 from unintentionally coming into contact with the parts of a cavity surface 22 located near the holding portions 29. Due thereto, it is possible to precisely arrange the protrusion portions 28 at desired positions inside the cavity 23.

Additionally, a plurality of the holding portions 29 are arranged so as to be spaced in the orthogonal direction. Therefore, it is possible to firmly hold the tips of the protrusion portions 28 by the holding portions 29, and the positions of the protrusion portions 28 inside the cavity 23 can be maintained with even higher precision.

Additionally, the protrusion portions 28 extend obliquely with respect to the thickness direction H, while the protrusion portions 29 extend straightly along the thickness direction II. Therefore, when closing the plurality of molds 21, the protrusion portions 28 can be smoothly elastically deformed, and the positions of the protrusion portions 28 inside the cavity 23 can be maintained with even higher precision.

Additionally, when releasing the seat pad 10, the holding portions 29 can be easily released from the seat pad 10.

Additionally, the protrusion portions 28 are formed on the cavity surface 22 of the lower mold 25 and protrude from the lower mold 25 towards the upper mold 24. Therefore, the seat pad 10 can be released by pulling it vertically from the cavity surface 22, so that the seat pad 10 can be easily released from the cavity surface 22.

Additionally, the protrusion portions 28 are provided with sliding portions 30. Therefore, when the plurality of molds 21 are closed, the protrusion portions 28 can be smoothly elastically deformed, and the positions of the protrusion portions 28 inside the cavity 23 can be maintained with even higher precision.

The technical scope of the present invention is not to be construed as being limited to the aforementioned embodiments, and various modifications can be made within a range not departing from the spirit of the present invention.

For example, the protrusion portions 28 may extend straightly in the thickness direction H. Additionally, the protrusion portions 28 may be provided on the lower mold 25 and the holding portions 29 may be provided on the upper mold 24. The holding portions 29 do not need to protrude from the cavity surface 22, and for example, may be formed by the cavity surface 22. Additionally, the sliding portion 30 is optional.

In the aforementioned embodiments, the seat pad 10 is formed integrally from different materials, but the present invention is not limited thereto. For example, the seat pad 10 may be formed integrally from the same material.

In the aforementioned embodiments, the slit portions 15 are separately provided at portions located on both sides, in the seat width direction B, of the seat pad 10, but the present invention is not limited thereto. A slit portion 15 may be provided on only one side in the seat width direction B. The present invention may be modified, as appropriate, to other embodiments in which one or a plurality of slit portions 15 are provided.

The seat pad 10 formed by the die 20 is used as a cushion pad, but the present invention is not to be construed as being limited thereto. For example, the seat pad 10 may be used as a back pad, or may be used as a seat pad for various applications, such as chairs for indoor use, or cushion materials for beds or the like. Furthermore, the seat pad 10 need not be limited to being for seating humans, and may have a loading surface for loading luggage or the like. Furthermore, the die 20 may be for forming a foam molded body that is different from the seat pad 10.

Aside therefrom, the constituent elements in the aforementioned embodiment may be replaced, as appropriate, with well-known constituent elements, within a range not departing from the spirit of the present invention, or the aforementioned modification examples may be combined as appropriate.

### INDUSTRIAL APPLICABILITY

According to the foam molded body production device of the present invention, it is possible to maintain the positions of protrusion portions inside a cavity with high precision, while ensuring the mold releasability of foam molded body.

### REFERENCE SIGNS LIST

10 Seat pad
20 Die (foam molded body production device)
21 Mold
22 Cavity surface
23 Cavity
24 Upper mold
25 Lower mold
28 Protrusion portion
29 Holding portion
30 Sliding portion

1. A foam molded body production device comprising:
a plurality of molds;
a cavity that is delimited, between the plurality of molds, by cavity surfaces of the plurality of molds; and
a protrusion portion that is formed on the cavity surfaces; wherein
the protrusion portion is formed from an elastic body; and
the cavity surfaces are provided with a holding portion that contacts a tip of the protrusion portion when the plurality of molds are closed, and causes the protrusion portion to elastically deform inside the cavity.

2. The foam molded body production device according to claim 1, wherein the holding portion protrudes from the cavity surfaces.

3. The foam molded body production device according to claim 2, wherein:
the protrusion portion extends in one direction in a plan view of the cavity surface on which the protrusion portion is formed; and
a plurality of the holding portions are arranged so as to be spaced in the one direction.

4. The foam molded body production device according to claim 2, wherein:
the protrusion portion extends obliquely with respect to an opening/closing direction of the plurality of molds; and
the holding portion extends straightly in the opening/closing direction.

5. The foam molded body production device according to claim 1, wherein:
the plurality of molds comprises an upper mold and a lower mold;
the protrusion portion is formed on the cavity surface of the upper mold and protrudes from the upper mold towards the lower mold; and
the holding portion is provided on the cavity surface of the lower mold.

6. The foam molded body production device according to claim 1, wherein the protrusion portion is provided with a sliding portion that elastically deforms the protrusion portion by sliding over the holding portion when the plurality of molds are closed.

7. A foam molded body production method for forming a foam molded body using the foam molded body production device according to claim 1, wherein:
the foam molded body is molded inside the cavity in which the tip of the protrusion portion is held by the holding portion, and thereafter, the plurality of molds are opened, and the foam molded body is released from the cavity surfaces while elastically deforming the protrusion portion.

8. A foam molded body that is formed by the foam molded body production method according to claim 7.
